(19) United States
(12) Patent Application Publication
(10) Pub. No.: US 2024/0333891 A1
(43) Pub. Date: Oct. 3, 2024

(54) DISPLAY METHOD, DISPLAY DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventors: Genta KAWABE, MATSUMOTO-SHI, NAGANO-KEN (JP); Yoshiteru UCHIYAMA, SUWA-SHI, NAGANO-KEN (JP)

(21) Appl. No.: 18/619,881

(22) Filed: Mar. 28, 2024

(30) Foreign Application Priority Data
Mar. 30, 2023 (JP) 2023-054905

(51) Int. Cl. H04N 9/31; G06F 3/0482; G06T 11/00

(52) U.S. Cl. CPC H04N 9/3179; G06F 3/0482; G06T 11/00; G06T 2200/24

(57) ABSTRACT

A controller of a projector acquires tag information indicating a content of a content image; displays a decoration image disposed along an outline of the content image outside the content image when the tag information meets a first condition; and displays the decoration image disposed along the outline of the content image outside the content image and having a different color or pattern, when the tag information meets a second condition, which is different from the first condition.

The present application is based on, and claims priority from JP Application Serial Number 2023-054905, filed Mar. 30, 2023, the disclosure of which is hereby incorporated by reference herein in its entirety.

### BACKGROUND

### 1. Technical Field

The present disclosure relates to a display method, a display device, and a non-transitory computer-readable storage medium storing a program.

### 2. Related Art

In the related art, there is a technique of providing an image suitable for user preferences.

For example, JP-A-2013-109239 discloses an image display device that includes an image display portion and a frame located around the image display portion and is configured such that a width of the frame can be variably controlled. The frame includes a non-image display region surrounding the image display portion and a frame portion surrounding the non-image display region. The width of the frame is variably controlled by changing a width of the non-image display region.

JP-A-2013-109239 is an example of the related art.

However, in the image display device disclosed in JP-A-2013-109239, a position and shape of the frame portion cannot be changed due to a structure of the image display device. Therefore, a degree of freedom of presentation or decoration performed on an image displayed by the image display portion is not high.

### SUMMARY

According to an aspect of the present disclosure, there is provided a display method including: acquiring content information indicating a content of a first image; displaying a second image disposed along an outline of the first image outside the first image when the content information meets a first condition; and displaying a third image disposed along the outline of the first image outside the first image and having a color or a pattern different from the second image, when the content information meets a second condition, which is different from the first condition.

According to an aspect of the present disclosure, there is provided a display device including: an optical device; and at least one processor, in which the at least one processor executes operations of acquiring content information indicating a content of a first image, displaying a second image disposed along an outline of the first image outside the first image by controlling the optical device when the content information meets a first condition, and displaying a third image disposed along the outline of the first image outside the first image and having a color or a pattern different from the second image by controlling the optical device, when the content information meets a second condition, which is different from the first condition.

According to an aspect of the present disclosure, there is provided a non-transitory computer-readable storage medium storing a program, the program causing a computer to execute operations including: acquiring content information indicating a content of a first image; displaying a second image disposed along an outline of the first image outside the first image when the content information meets a first condition; and displaying a third image disposed along the outline of the first image outside the first image and having a color or a pattern different from the second image, when the content information meets a second condition, which is different from the first condition.

### BRIEF DESCRIPTION OF THE DRAWINGS

FIG. 1 is a block diagram showing a configuration of a projector.

FIG. 2 is a diagram showing an example of a content image.

FIG. 3 is a diagram showing an example of a decoration image.

FIG. 4 is a diagram showing an example of a composite image.

FIG. 5 is a diagram showing a first UI image.

FIG. 6 is a flowchart showing an operation of a projector according to a first embodiment.

FIG. 7 is a diagram showing a configuration of a registration table.

FIG. 8 is a flowchart showing an operation of a projector according to a second embodiment.

FIG. 9 is a diagram showing a second UI image.

FIG. 10 is a diagram showing an example of an OSD image superimposed on a composite image.

### DESCRIPTION OF EMBODIMENTS

Hereinafter, embodiments of the present disclosure will be described with reference to the drawings.

### 1. Configuration of Projector According to First Embodiment

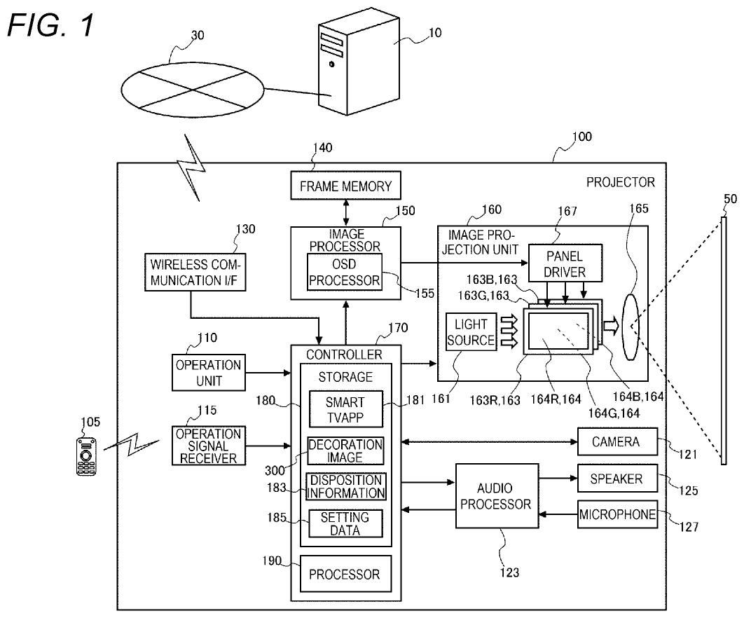

FIG. 1 is a block diagram showing a configuration of a projector 100.

The configuration of the projector 100 will be described with reference to FIG. 1.

The projector 100 includes an operation unit 110, an operation signal receiver 115, a camera 121, an audio processor 123, a speaker 125, a microphone 127, a wireless communication interface 130, a frame memory 140, an image processor an image projection unit 160, and a controller 170. Hereinafter, the interface is abbreviated as an I/F.

The operation unit 110 includes a plurality of operation keys. A user inputs various instructions to the projector 100 by operating the operation keys of the operation unit 110. When the user operates the operation key of the operation unit 110, the operation unit 110 outputs, to the controller 170, an operation signal corresponding to the operated operation key. The operation keys of the operation unit 110 include a power key for switching power on and off, a menu key for displaying a menu for performing various settings, a direction key for selecting a menu item, and an enter key for determining an operation.

The operation signal receiver 115 is a receiving device for an infrared signal, and includes a light receiving element, a decoder, and the like (not shown). The operation signal receiver 115 receives and decodes an infrared signal transmitted from a remote control 105. The operation signal receiver 115 decodes the infrared signal and outputs, to the controller 170, an operation signal corresponding to the operated operation key or button on the remote control 105. The operation signal receiver 115 may receive a wireless signal by Bluetooth or the like from the remote control 105. Bluetooth is a registered trademark. When receiving a wireless signal, the operation signal receiver 115 may include an antenna and a reception circuit. The operation unit 110 and the operation signal receiver 115 can also be referred to as an operation input I/F.

The remote control 105 includes a plurality of operation keys similar to those of the operation unit 110. For example, the remote control 105 includes a menu key for displaying a menu for performing various settings, a direction key for selecting a menu item, and an enter key for determining an operation. The remote control 105 may be a mobile terminal such as a smartphone. In this case, an I/F image of the operation key is displayed on a touch panel of the mobile terminal by application software installed in the mobile terminal.

The camera 121 includes an image-capturing lens and an image-capturing element such as a charge coupled device (CCD) or a complementary MOS (CMOS), and generates a captured image according to an instruction from the controller 170. The camera 121 outputs the generated captured image to the controller 170. The controller 170 temporarily stores the input captured image from the camera 121 in a storage 180. In the embodiment, a configuration in which the projector 100 includes the camera 121 is described, but the camera 121 may be externally coupled to the projector 100.

The audio processor 123 includes a digital to analog (D/A) conversion circuit, converts digital audio data input from the controller 170 into analog audio data, and outputs the converted analog audio data to the speaker 125.

The audio processor 123 includes an analog to digital (A/D) conversion circuit, converts analog audio data input from the microphone 127 into digital audio data, and outputs the converted digital audio data to the controller 170. The digital audio data is temporarily stored in the storage 180.

The speaker 125 outputs the analog audio data input from the audio processor 123.

The microphone 127 collects sounds to generate an analog signal, and outputs the generated analog audio data to the audio processor 123.

The wireless communication I/F 130 is a wireless communication module for performing wireless communication in compliance with a communication standard such as 4 generation (G), 5G, long term evolution (LTE), or Wi-Fi. The wireless communication I/F 130 is coupled to a server device 10 via a network 30, and receives packet data supplied from the server device 10. The packet data includes a content image 200 and audio data. The wireless communication I/F 130 extracts the content image 200 and the audio data in the packet data, and outputs the extracted content image 200 and audio data to the controller 170. Wi-Fi is a registered trademark. The projector 100 may include an image input I/F (not shown) including a connector and an interface circuit, and may receive the content image 200 and the audio data from the server device 10 or an information processing device via a cable.

The frame memory 140 is coupled to the image processor 150. The image processor 150 includes an on screen display (OSD) processor 155.

The image processor 150 loads the content image 200 and a decoration image 300 input from the controller 170 into the frame memory 140.

The OSD processor 155 superimposes an OSD image on the image loaded into the frame memory 140 under control of the controller 170. The OSD processor 155 includes an OSD memory (not shown). The OSD memory stores OSD image information representing figures, fonts, and the like for forming the OSD image. When the OSD processor 155 is instructed by the controller 170 to superimpose an OSD image, the OSD processor 155 reads necessary OSD image information from the OSD memory and superimposes the OSD image on an image loaded into the frame memory 140.

The image processor 150 performs, for example, an image process on the image loaded into the frame memory 140, such as a resolution conversion process, a resizing process, distortion aberration correction, a shape correction process, a digital zoom process, and adjustment of hue or luminance of the image. The image loaded into the frame memory 140 is an input image or an image in which an OSD image is superimposed on the input image.

The image processor 150 outputs image information, which is information on the image loaded into the frame memory 140, to a panel driver 167 of the image projection unit 160.

The frame memory 140 and the image processor 150 are implemented with an integrated circuit, for example. The integrated circuit includes a large scale integrated circuit (LSI), an application specific integrated circuit (ASIC), a programmable logic device (PLD), a field-programmable gate array (FPGA), a system-on-a-chip (SoC), and the like. The frame memory 140 and the image processor 150 may include an analog circuit as a part of a configuration of the integrated circuit, or may have a configuration in which the controller 170 and the integrated circuit are combined.

The image projection unit 160 includes a light source 161, three liquid crystal panels 163R, 163G, and 163B as a light modulation device, a projection lens 165 as an optical system unit, and the panel driver 167. Hereinafter, the liquid crystal panels 163R, 163G, and 163B are collectively referred to as a liquid crystal panel 163. The light source 161, the liquid crystal panels 163R, 163G, and 163B, and the projection lens 165 in the image projection unit 160 correspond to an optical device.

The light source 161 includes a solid-state light source such as a light-emitting diode or a semiconductor laser. As the light source 161, a discharge type light source lamp such as an ultra-high pressure mercury lamp or a metal halide lamp may be used. A light emitted from the light source 161 according to an instruction from the controller 170 is converted into a light having a substantially uniform luminance distribution by an integrator optical system (not shown), and is separated into color light components of red (R), green (G), and blue (B) that are three primary colors of lights by a color separation optical system (not shown). Thereafter, the light separated into the color light components of red (R), green (G), and blue (B) is respectively incident on the liquid crystal panels 163R, 163G, and 163B. The light separated into the color light components incident on the liquid crystal panels 163R, 163G, and 163B is referred to as a color light.

Each of the liquid crystal panels 163R, 163G, and 163B is implemented with a transmissive liquid crystal panel in which liquid crystal is sealed between a pair of transparent substrates. In each liquid crystal panel 163, rectangular image forming regions 164R, 164G, and 164B including a plurality of pixels arranged in a matrix are formed, and a drive voltage can be applied to each pixel.

The panel driver 167 forms images in the image forming regions 164R, 164G, and 164B of the liquid crystal panels 163R, 163G, and 163B. Specifically, in accordance with an instruction from the controller 170, the panel driver 167 applies a drive voltage corresponding to image information input from the image processor 150 to each pixel of the image forming regions 164R, 164G, and 164B, and sets each pixel to light transmittance corresponding to the image information. A light emitted from the light source 161 is transmitted through the image forming regions 164R, 164G, and 164B of the liquid crystal panels 163R, 163G, and 163B to be modulated for each pixel, and an image light corresponding to the image information is formed for each color light. The formed image lights with each color are combined for each pixel by a color composition optical system (not shown) to become an image light representing a color image, and is enlarged and projected on a screen 50 that is a projection surface by the projection lens 165. In the embodiment, a case where the projection surface is the screen 50 is shown, but it is also possible to use an indoor wall surface, a ceiling, an outdoor outer wall, or the like as the projection surface.

The controller 170 includes the storage 180 and a processor 190.

The storage 180 includes a volatile storage device and a nonvolatile storage device.

The volatile storage device includes, for example, a random access memory (RAM). The nonvolatile storage device is implemented with, for example, a read only memory (ROM), a flash memory, and an electrically erasable programmable read-only memory (EEPROM).

The volatile storage device is used as a calculation area for the processor 190.

The nonvolatile storage device stores a control program executed by the processor 190, the decoration image 300, disposition information 183, and setting data 185. The control program includes an application program. The nonvolatile storage device according to the embodiment stores, as the application program, an application program for implementing a function of a smart TV. This application program is referred to as a smart TVAPP 181. Details of the decoration image 300, the disposition information 183, and the smart TVAPP 181 will be described later.

The setting data 185 is various types of setting data for operating the projector 100, and in a first embodiment, the setting data 185 includes combination information. The combination information is information that associates information indicating a genre of the content image 200 with identification information for identifying the decoration image 300.

The processor 190 is an arithmetic processing device including a processor such as a central processing unit (CPU) or a micro-processing unit (MPU). The processor 190 may be implemented with a single processor, or may be implemented with a plurality of processors. The processor 190 may be implemented with an SoC integrated with part or all of the storage 180 or other circuits. The processor 190 may be implemented with a combination of a CPU that executes a program and a digital signal processor (DSP) that executes a predetermined arithmetic process. Further, all functions of the processor 190 may be implemented in hardware, or a programmable device may be used.

### 2. Operation of Projector in First Embodiment

In the following description, the projector 100 projecting an image light onto the screen 50 to form an image on the screen 50 is referred to as a display. The image displayed on the screen 50 by the projector 100 is referred to as a projection image.

The projector 100 has a first mode and a second mode as a display mode for displaying an image on the screen 50.

In the first mode, the projector 100 combines the decoration image 300 with the content image 200 received from the server device 10 to generate a composite image 400. The projector 100 displays, on the screen 50, an image light based on the generated composite image 400.

In the second mode, the projector 100 displays the content image 200 on the screen 50. That is, when operating in the second mode, the projector 100 generates an image light based on the content image 200 without combining the decoration image 300 with the content image 200, and displays the generated image light on the screen 50.

The user can switch an operation mode of the projector 100 between the first mode and the second mode by operating the remote control 105 or the operation unit 110.

A size of the entire composite image 400 displayed by the projector 100 in the first mode is the same as a size of the content image 200 displayed by the projector 100 in the second mode. In the first mode, the content image 200 is in the composite image 400. Therefore, a size of the content image 200 displayed in the first mode is smaller than the size of the content image 200 displayed in the second mode.

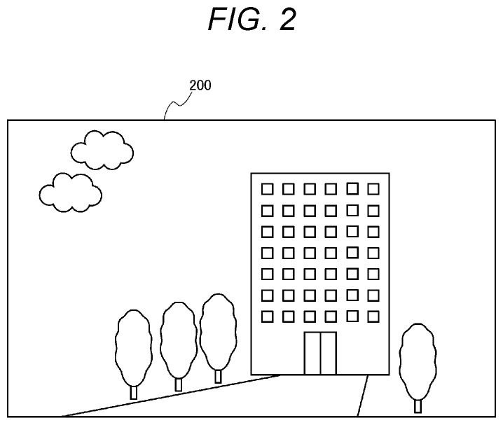

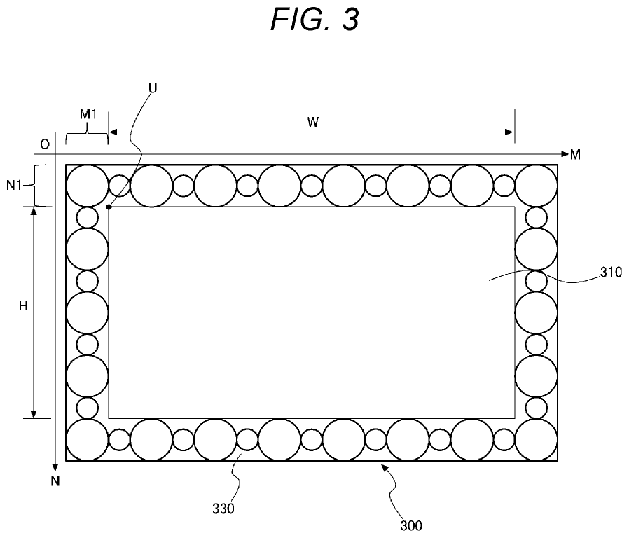

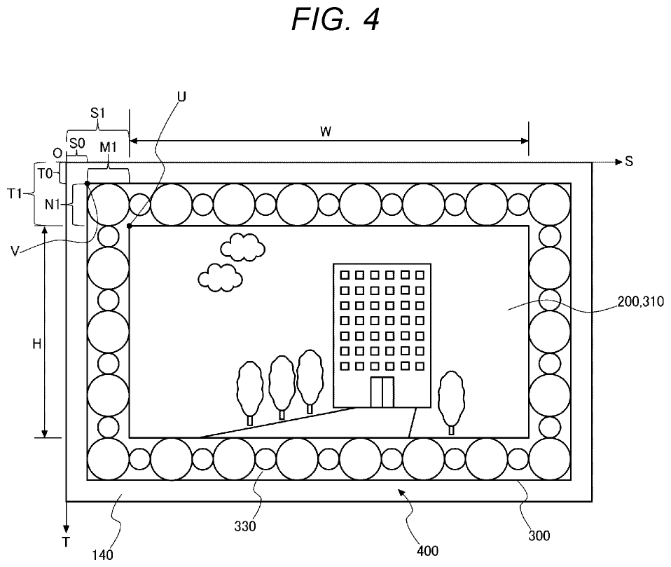

FIG. 2 is a diagram showing an example of the content image 200. FIG. 3 is a diagram showing an example of the decoration image 300. FIG. 4 is a diagram showing an example of the composite image 400.

The content image 200 is an image input from an outside or an image stored in the storage 180 in advance. In the embodiment, a case where the content image 200 is an image distributed by streaming from the server device 10 will be described. That is, the content image 200 is distributed by streaming from the server device 10 when the controller 170 that executes the smart TVAPP 181 transmits a request to distribute the server device 10.

In addition, the content image 200 may be an image supplied to the projector 100 by the information processing device. That is, the information processing device may be coupled to the projector 100, and the content image 200 may be supplied from the information processing device to the projector 100. As the information processing device, for example, a notebook personal computer (PC), a desktop PC, a tablet PC, a smartphone, or a game device is used.

The decoration image 300 is, for example, an image stored in advance in the storage 180 of the projector 100 and can be combined with various content images 200. The decoration image 300 may be stored in the storage 180 as a so-called template. The projector 100 may store a plurality of decoration images 300 in the storage 180. The projector 100 may download the decoration image 300 from the server device 10, for example. The projector 100 may be configured to read, from an external storage device, the decoration image 300 stored in the storage device such as a universal serial bus (USB) memory or an SD card and use the decoration image 300.

The decoration image 300 is, for example, a rectangular image, and includes a disposition portion 310 and a frame 330.

The disposition portion 310 is located at a center of the decoration image 300, and the frame 330 is disposed along an outline of the disposition portion 310 over an entire periphery of the disposition portion 310. The disposition portion 310 is a region in which the content image 200 is disposed when the composite image 400 is generated. The image processor 150 superimposes the content image 200 on the disposition portion 310 of the decoration image 300 loaded into the frame memory 140. At this time, the frame 330 is disposed along an outline of the content image 200 outside the content image 200.

The frame 330 is a region in which a decoration image for decorating the content image 200 disposed in the disposition portion 310 is formed. An image formed at the frame 330 is different for each of a plurality of decoration images 300. That is, appearances of the plurality of decoration images 300 are different in color, pattern, and the like.

FIG. 3 shows an example of the decoration image 300 in which the frame 330 is formed around an entire periphery of the decoration image 300, but the frame 330 may be formed at any one side, two sides, or three sides of upper, lower, left, and right sides of the rectangular decoration image 300.

The decoration image 300 includes the disposition information 183 which is information indicating a position and a range in which the content image 200 is disposed inside the decoration image 300. The disposition information 183 includes starting point information, and width and height information.

For example, a coordinate system is set for the decoration image 300. FIG. 3 shows a coordinate system in which an upper left vertex of the decoration image 300 is an origin, a horizontal coordinate of the decoration image 300 is an M-axis, and a vertical coordinate is an N-axis. Hereinafter, the coordinate system set in the decoration image 300 is described as an MN coordinate system.

The starting point information is coordinate information indicating a position of a starting point serving as a reference when the content image 200 is disposed in the disposition portion 310. In the embodiment, an upper left vertex U of the disposition portion 310 is set as a starting point when viewed in the drawing. Coordinates of the vertex U in the MN coordinate system are denoted as (M1, N1).

The width information is information indicating a width W in an M-axis direction from the vertex U as the starting point. The height information is information indicating a height H in an N-axis direction from the vertex U as the starting point.

In the first embodiment, in the first mode, the decoration image 300 to be combined with the content image 200 is changed according to the genre of the content image 200. The genre of the content image 200 includes a movie, a game image, music, and the like. Hereinafter, a case where the genre of the content image 200 is a movie will be described as a first genre, and a case where the genre of the content image 200 is a game image will be described as a second genre. In addition to the first genre and the second genre, a third genre and a fourth genre may be set.

When the genre of the input content image 200 is a movie that is the first genre, the projector 100 determines that a first condition is met. When the genre of the input content image 200 is the second genre and is a game, it is determined that a second condition different from the first condition is met.

Different decoration images 300 are associated depending on whether the genre of the content image 200 meets the first condition or the second condition. The decoration image 300 when the genre of the content image 200 meets the first condition corresponds to a second image. The decoration image 300 when the genre of the content image 200 meets the second condition corresponds to a third image. The decoration images 300 respectively associated with the case where the genre meets the first condition and the case where the genre meets the second condition can be changed by an operation on the remote control 105 or the operation unit 110 by the user. The decoration image 300 to be combined with the content image 200 when the first condition is satisfied and the decoration image 300 to be combined with the content image 200 when the second condition is satisfied are images having different colors, patterns, and the like.

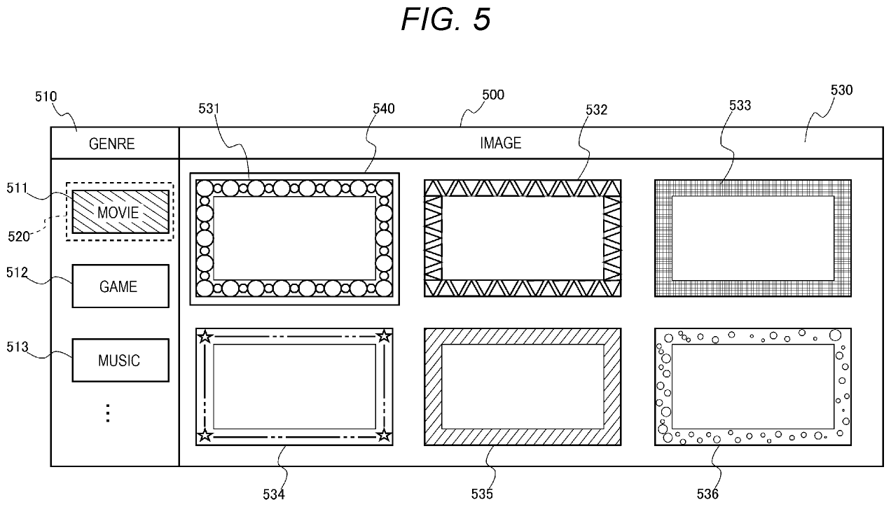

FIG. 5 is a diagram showing a first user interface (UI) image 500 displayed on the screen 50. The first UI image 500 is an operation image for receiving an operation of the user, and is an image used to generate combination information for combining the genre of the content image 200 and the decoration image 300.

Here, a combination of the genre of the content image 200 and the decoration image 300 will be described. The user operates the remote control 105 to display the first UI image 500 shown in FIG. 5 and set a combination of the genre of the content image 200 and the decoration image 300. The genres shown in the first UI image 500 correspond to a plurality of candidate conditions.

A genre selection field 510 and an image selection field 530 are displayed in the first UI image 500.

The genre selection field 510 is a field for selecting a genre of the content image 200. In the genre selection field 510, objects corresponding to each genre such as a movie, a game, and music are displayed. FIG. 5 shows an example in which three objects, a first object 511, a second object 512, and a third object 513, are displayed as objects, but the number of objects displayed in the genre selection field 510 is not limited to three, and may be four or more. The number of objects displayed in the genre selection field 510 may be two or less.

The first object 511 is an object indicating a genre as a movie. The second object 512 is an object indicating a genre as a game. The third object 513 is an object indicating a genre as music.

A selection frame 520 is displayed in the genre selection field 510. A display position of the selection frame 520 can be moved in an upper-lower direction when viewed in the drawing in the genre selection field 510 by an operation on the remote control 105 by the user. For example, when a down key on the remote control 105 is pressed while the first object 511 shown in FIG. 5 is surrounded by the selection frame 520, the selection frame 520 moves downward when viewed in the drawing and the second object 512 is surrounded by the selection frame 520.

In the embodiment, a frame-shaped image surrounding a periphery of an object is displayed as the selection frame 520, but for example, check boxes corresponding to each object may also be displayed. An image having a shape other than the frame may be added to the selected object, or the selected object itself may be emphasized by an enlarged display. The selection frame 520 can also be referred to as a selection cursor, a focus display, or the like. The display position of the selection frame 520 in the first UI image 500 is changed by an operation on the direction key provided on the remote control 105.

The image selection field 530 is a field for selecting the decoration image 300. In the image selection field 530, a thumbnail image of the decoration image 300 is displayed. The thumbnail image corresponds to a candidate image. FIG. 5 shows six thumbnail images, i.e., a first thumbnail image 531, a second thumbnail image 532, a third thumbnail image 533, a fourth thumbnail image 534, a fifth thumbnail image 535, and a sixth thumbnail image 536. The number of thumbnail images displayed in the image selection field 530 is not limited to six, and seven or more thumbnail images may be displayed, or five or less thumbnail images may be displayed.

A selection frame 540 is displayed in the image selection field 530. A display position of the selection frame 540 can be moved in the upper-lower direction and a left-right direction when viewed in the drawing in the image selection field 530 by an operation on the remote control 105 by the user. For example, when a right key on the remote control 105 is pressed while the first thumbnail image 531 shown in FIG. 5 is surrounded by the selection frame 540, the selection frame 540 moves to the right direction when viewed in the drawing, and the second thumbnail image 532 is surrounded by the selection frame 540.

In the embodiment, a frame-shaped image surrounding a periphery of the thumbnail image is displayed as the selection frame 540, but for example, check boxes corresponding to each thumbnail image may also be displayed. An image having a shape other than the frame may be added to the selected thumbnail image, or the selected thumbnail image itself may be emphasized by an enlarged display. The selection frame 540 can also be referred to as a selection cursor, a focus display, or the like. The display position of the selection frame 540 in the first UI image 500 is changed by an operation on the direction key provided on the remote control 105.

When a decision button on the remote control 105 is pressed by the user, the controller 170 generates combination information that associates the object surrounded by the selection frame 520 in the genre selection field 510 with the thumbnail image surrounded by the selection frame 540 in the image selection field 530. That is, the controller 170 generates combination information that associates information indicating the genre corresponding to the object surrounded by the selection frame 540 with identification information for identifying the decoration image 300 corresponding to the thumbnail image surrounded by the selection frame 540. The controller 170 stores the generated combination information as the setting data 185 in the storage 180.

Subsequently, the user operates the remote control 105 to change the display position of the selection frame 520 for other objects in an unselected state, and brings the object in the unselected state to a selected state. Further, the user operates the remote control 105 to change the display position of the selection frame 540, and selects a thumbnail image of the decoration image 300 to be combined with the content image 200 when the genre of the object is in the selected state. In this manner, the user generates combination information in which identification information on the decoration image 300 is associated with each genre. It is not necessary to generate combination information in which the identification information on the decoration image 300 is associated with all the genres using the first UI image 500. When there is a genre in which combination information is not generated, the controller 170 may select the default decoration image 300 set in advance for the genre, and may generate the composite image 400 by combining the selected decoration image 300 with the content image 200. When there is a genre for which the combination information is not generated, the controller 170 may not associate the decoration image 300 with the genre. In this case, only the content image 200 is displayed for the genre to which the decoration image 300 is not associated.

Processes executed by the projector 100 in the first mode will be described. When causing the projector 100 to start projecting a projection image onto the screen 50, the user first operates the remote control 105 to activate the smart TVAPP 181.

The controller 170 executing the smart TVAPP 181 displays, on the screen 50, a selection screen on which thumbnails or the like of a plurality of content images 200 available for viewing are displayed, and waits until the user inputs a selection of the content image 200.

When the user operates the remote control 105 to select the content image 200, the controller 170 transmits, to the server device 10, a request to distribute the selected content image 200 and a request to acquire tag information indicating a genre of the content image 200. The tag information is information indicating a content of the content image 200. The tag information corresponds to content information.

Upon receiving the tag information from the server device 10, the controller 170 determines the genre of the content image 200 distributed from the server device 10 based on the received tag information, refers to the combination information, and selects the decoration image 300 associated with the determined genre. The controller 170 reads the selected decoration image 300 from the storage 180, and outputs the read decoration image 300 to the image processor 150. The image processor 150 loads the decoration image 300 input from the controller 170 into the frame memory 140.

When streaming distribution of the content image 200 selected by the user is started by the server device 10, the projector 100 receives distributed packet data through the wireless communication I/F 130. The wireless communication I/F 130 extracts the content image 200 and audio data in the received packet data, and outputs the extracted content image 200 and audio data to the controller 170.

The controller 170 outputs the content image 200 input from the wireless communication I/F 130 to the image processor 150 and outputs the audio data to the audio processor 123.

When the content image 200 is input from the controller 170, the image processor 150 executes a reduction process of reducing the input decoration image 300.

As described above, the size of the content image 200 input to the image processor 150 is the same size as the composite image 400, and is larger than the disposition portion 310 of the decoration image 300. Therefore, the image processor 150 executes the reduction process of reducing the input content image 200 in accordance with a size of the disposition portion 310.

First, the image processor 150 compares resolution of the input content image 200 with width and height information in the disposition information 183 to calculate a reduction ratio at which the content image 200 is reduced. As an example, the reduction ratio is a ratio of resolution corresponding to the width W and the height H to the resolution of the content image 200, but a calculation method is not limited to this example.

After calculating the reduction ratio, the image processor 150 executes a reduction process of reducing the content image 200 at the determined reduction ratio.

Next, the image processor 150 executes a combination process.

FIG. 4 shows the composite image 400 loaded into the frame memory 140. The composite image 400 shown in FIG. 4 is an example in which an image process such as shape correction is not performed by the image processor 150.

For example, a coordinate system is set in the frame memory 140. FIG. 4 shows, when viewed in the drawing, an orthogonal plane coordinate system in which an upper left vertex O of the frame memory 140 is set as an origin, a horizontal coordinate of the frame memory 140 is an S axis, and a vertical coordinate is a T axis. In the following description, the coordinate system set in the frame memory 140 is described as an ST coordinate system.

The image processor 150 generates the composite image 400 in the frame memory 140 by superimposing the content image 200 reduced by the reduction process on the decoration image 300. The image processor 150 generates the composite image 400 having a size equal to or smaller than a maximum size of an image that can be loaded into the frame memory 140 in order to store the entire composite image 400 in the frame memory 140. The maximum size of the image that can be loaded into the frame memory 140 is the same as a maximum size of an image that can be drawn in the image forming region 164 of the liquid crystal panel 163. That is, the size of the composite image 400 is equal to or smaller than the maximum size of the image that can be loaded into the frame memory 140. By making the size of the composite image 400 smaller than the maximum size of the image that can be drawn in the image forming region 164, it is possible to change a position and shape of the composite image 400 drawn on the liquid crystal panel 163, and change a size of enlargement and reduction. Therefore, a degree of freedom of the composite image 400 displayed on the screen 50 can be increased, and convenience for the user can be improved.

In FIG. 4, coordinates of an upper left vertex V of the decoration image 300 loaded into the frame memory 140 are assumed to be (S0, T0). The image processor 150 calculates a coordinate value S1 by adding the coordinate value M1 in an M coordinate of the starting point information in the disposition information 183 to S0, which is an S coordinate value of the upper left vertex V of the decoration image 300, as the S coordinate value of the vertex U in the ST coordinate system.

Similarly, the image processor 150 calculates a coordinate value T1 by adding the coordinate value N1 in an N coordinate of the starting point information in the disposition information 183 to T0, which is a T coordinate value of the upper left vertex V of the decoration image 300, as the T coordinate value of the vertex U in the ST coordinate system.

Next, based on the disposition information 183 and the coordinate values of the vertex U in the ST coordinate system, the image processor 150 superimposes the content image 200 reduced by the reduction process on the disposition portion 310 of the decoration image 300 loaded into the frame memory 140.

The image processor 150 generates the composite image 400 by superimposing the content image 200 on the disposition portion 310 of the decoration image 300 loaded into the frame memory 140 such that an upper left vertex of the content image 200 is located at the coordinates of the vertex U in the ST coordinate system. An image of the disposition portion 310 of the decoration image 300 loaded into the frame memory 140 before the content image 200 is superimposed is rewritten to the content image 200.

Accordingly, the content image 200 is loaded into a region of the frame memory 140 into which the disposition portion 310 of the decoration image 300 is loaded, and an image of the frame 330 is left in the frame memory 140 as it is. In the process, the composite image 400 is generated so that the disposition portion 310 of the decoration image 300 does not overlap the content image 200, which is a first image.

After generating the composite image 400, the image processor 150 may perform, for example, an image process such as a resolution conversion process, a resizing process, distortion aberration correction, a shape correction process, a digital zoom process, and adjustment of hue or luminance of an image on the generated composite image 400. These image processes are not essential processes, and the image processor 150 may not execute the above image process. The image processor 150 may execute a combination of a plurality of image processes among the above image processes.

When the image process is ended, the image processor 150 reads the image information on the composite image 400 loaded into the frame memory 140, and outputs the read image information to the panel driver 167 of the image projection unit 160.

When the image information is input from the image processor 150, the image projection unit 160 applies a drive voltage corresponding to the input image information to each pixel of the image forming regions 164R, 164G, and 164B, and sets each pixel to light transmittance corresponding to the image information. A light emitted from the light source 161 is separated into R, G, and B color lights by the color separation optical system, and passes through the image forming regions 164R, 164G, and 164B of the liquid crystal panels 163R, 163G, and 163B. Accordingly, the color light is modulated for each pixel, and an image light corresponding to the image information is formed for each color light. The formed image lights with each color are combined for each pixel by a color composition optical system (not shown) to become an image light representing a color image, and is enlarged and projected on a screen 50 that is a projection surface by the projection lens 165. At this time, the composite image 400 displayed on the screen 50 is displayed on the screen 50 such that the frame 330 of the decoration image 300 and the content image 200 do not overlap.

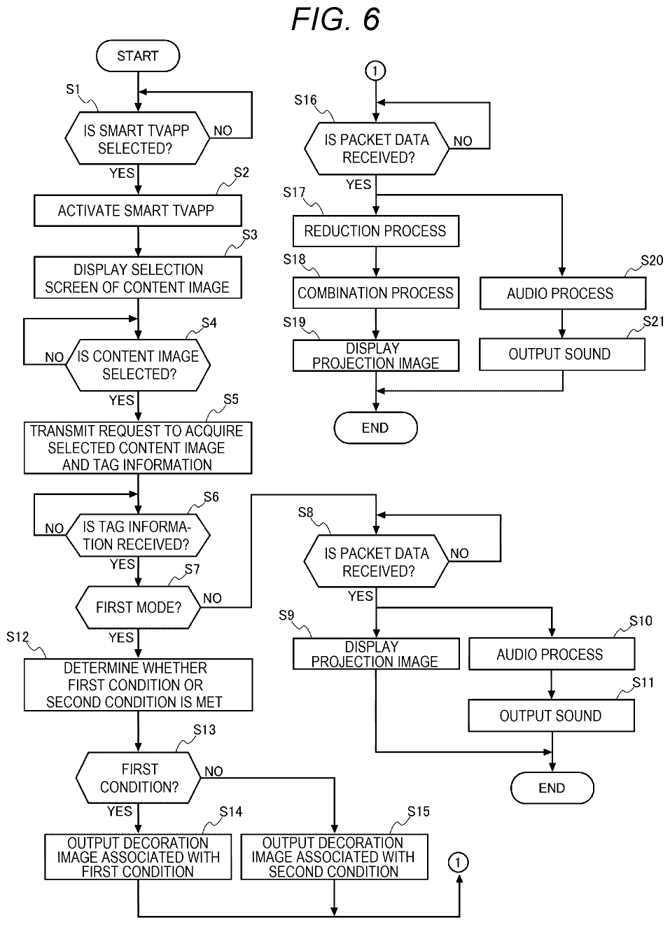

FIG. 6 is a flowchart showing an operation of the projector 100.

The operation of the projector 100 will be described with reference to the flowchart shown in FIG. 6.

First, the controller 170 determines whether the smart TVAPP 181 is selected (step S1). Specifically, the controller 170 determines whether an operation of activating the smart TVAPP 181 is received from the remote control 105.

When the smart TVAPP 181 is not selected (step S1: NO), the controller 170 waits until the smart TVAPP 181 is selected. When the smart TVAPP 181 is selected (step S1: YES), the controller 170 activates the smart TVAPP 181 (step S2). Then, the controller 170 displays a selection screen of the content image 200 provided by the smart TVAPP 181 on the screen 50 (step S3).

Next, the controller 170 determines whether the content image 200 is selected (step S4). Specifically, the controller 170 determines whether an operation of selecting the content image 200 is received from the remote control 105.

When the content image 200 is not selected (step S4: NO), the controller 170 waits until the content image 200 is selected. When the content image 200 is selected (step S4: YES), the controller 170 transmits, to the server device 10, a request to acquire the selected content image 200 and tag information (step S5).

Next, the controller 170 determines whether the tag information is received from the server device 10 (step S6). When the tag information is not received (step S6: NO), the controller 170 waits until the tag information is received.

When the tag information is received from the server device 10 (step S6: YES), the controller 170 determines whether the operation mode of the projector 100 is the first mode (step S7).

When the operation mode of the projector 100 is not the first mode (step S7: NO) but the second mode, the controller 170 determines whether the wireless communication I/F 130 receives the packet data distributed from the server device 10 (step S8). When the packet data is not received (step S8: NO), the controller 170 waits until the packet data is received.

When the wireless communication I/F 130 receives the packet data (step S8: YES), the controller 170 causes the projection image to be projected onto the screen 50 and causes the speaker 125 to output a sound. Specifically, the wireless communication I/F 130 extracts the content image 200 and audio data in the received packet data, and outputs the extracted content image 200 and audio data to the controller 170. The controller 170 outputs the input content image 200 to the image processor 150, and outputs the input audio data to the audio processor 123.

The image processor 150 loads the input content image 200 into the frame memory 140, and performs an image process on the loaded content image 200, such as adjustment of hue or luminance of the image. The image processor 150 reads image information on the content image 200 after the image process and outputs the image information to the image projection unit 160. The image projection unit 160 generates an light based on the input image information, projects the generated image light, and displays the projection image on the screen 50 (step S9).

The audio processor 123 performs an audio process such as converting input digital audio data into an analog signal (step S10), and outputs the converted analog signal from the speaker 125 (step S11).

When the operation mode of the projector 100 is the first mode (step S7: YES), the controller 170 determines, based on the tag information, whether a genre indicated by the tag information meets the first condition or the second condition (step S12). For example, the controller 170 determines, based on the tag information, whether the genre of the content image 200 selected in step S4 is a movie as the first condition or a game as the second condition.

When the genre of the content image 200 is a movie, the controller 170 determines that the first condition is selected (step S13: YES), and outputs the decoration image 300 associated with the first condition to the image processor 150 (step S14). When the genre of the content image 200 is a game, the controller 170 determines that the second condition is selected (step S13: NO), and outputs the decoration image 300 associated with the second condition to the image processor 150 (step S15). The image processor 150 loads the decoration image 300 input from the controller 170 into the frame memory 140.

Next, the controller 170 determines whether the wireless communication I/F 130 receives the packet data distributed from the server device 10 (step S16). When the packet data is not received (step S16: NO), the controller 170 waits until the packet data is received.

When the wireless communication I/F 130 receives the packet data (step S16: YES), the controller 170 causes the projection image to be projected onto the screen 50 and causes the speaker 125 to output a sound. Specifically, the wireless communication I/F 130 extracts the content image 200 and audio data in the received packet data, and outputs the extracted content image 200 and audio data to the controller 170. The controller 170 outputs the input content image 200 to the image processor 150, and outputs the input audio data to the audio processor 123.

When the content image 200 is input from the controller 170, the image processor 150 compares resolution of the input content image 200 with width and height information in the decoration image 300 to calculate a reduction ratio at which the content image 200 is reduced. After calculating the reduction ratio, the image processor 150 performs a reduction process of reducing the content image 200 at the calculated reduction ratio (step S17).

Next, the image processor 150 superimposes the content image 200 reduced by the reduction process on the disposition portion 310 of the decoration image 300 loaded into the frame memory 140, and executes a combination process (step S18). Accordingly, the composite image 400 is generated in the frame memory 140.

Next, the image processor 150 performs an image process on the composite image 400 generated in the frame memory 140, such as adjustment of hue or luminance of the image. The image processor 150 reads image information on the composite image 400 after the image process and outputs the image information to the image projection unit 160. The image projection unit 160 generates an image light based on the input image information, projects the generated image light, and displays a projection image on the screen 50 (step S19).

The audio processor 123 performs an audio process such as converting digital audio data input from the controller 170 into an analog signal (step S20), and outputs the converted analog signal from the speaker 125 (step S21).

### 3. Operation of Projector in Second Embodiment

Next, a second embodiment to which the present disclosure is applied will be described. Since a configuration of the projector 100 according to the second embodiment is the same as the configuration of the projector 100 according to the first embodiment, the same reference signs are used, and a detailed description of the configuration of the projector 100 will be omitted.

In the second embodiment, the controller 170 determines, based on a captured image captured by the camera 121 or audio data input from the microphone 127, a first scene or a second scene that is a situation or a scene displayed in the content image 200 that is a video that changes over time.

For example, when the content image 200 is a game image, the situation of the content image 200 includes winning or losing of a game. When the content image 200 is a game image, the scene of the content image 200 includes a location such as a street or a forest displayed by an image in the content image 200.

When the content image 200 is a movie, the scene of the content image 200 includes a scene or the like in which an emotion such as joy, anger, sadness, or delight of a character appearing in the movie is expressed.

For example, the controller 170 analyzes a captured image captured by the camera 121, and determines that the user wins the game when characters such as “WIN” or “VICTORY” are detected from a range of the captured image in which the content image 200 is captured.

When characters such as “LOSE”, “GAME OVER”, and “LOSS” are detected from the range of the captured image in which the content image 200 is captured, the controller 170 determines that the user loses the game.

The controller 170 analyzes the captured image captured by the camera 121, and determines that a location displayed by the content image 200 is in a forest when a group of trees is detected from the range of the captured image in which the content image 200 is captured.

The controller 170 analyzes the captured image captured by the camera 121, and determines that a location displayed by the content image 200 is on a street when a plurality of houses or buildings are detected from the range of the captured image in which the content image 200 is captured.

For example, the controller 170 detects a sound of a preset sound pattern such as cheer or clapping from the audio data input from the microphone 127, thereby determining that the scene is a scene in which a character appearing in a movie or a game is happy.

The controller 170 detects a preset sound pattern such as gunshots from the input audio data, thereby determining that the scene of the movie or the game is a battle scene.

In addition, the controller 170 may detect, from the input audio data, a change in a volume of a song or a change in a tempo of a song played as BGM in a movie or a game. Further, the controller 170 may perform Fourier transform on the audio data to detect a frequency component of a sound in the audio data.

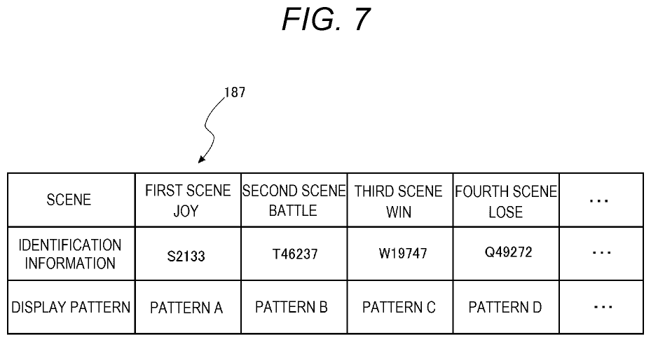

FIG. 7 is a diagram showing an example of a configuration of a registration table 187. The registration table 187 is a table stored in the storage 180 in advance.

In one record of the registration table 187, information indicating a scene such as JOY, BATTLE, WIN, and LOSE, identification information on the decoration image 300, and a display pattern are registered in association with each other. The display pattern is information indicating a pattern for changing a display of the decoration image 300. In the embodiment, a display of the decoration image 300 is changed by changing a display color of the decoration image 300, or by blinking a portion of the decoration image 300 or the entire decoration image 300.

For example, when the display pattern is a pattern that changes the display color of the decoration image 300, the display pattern includes information that defines whether the display color is changed, a color to be displayed, and a time interval at which the color is changed. The time interval can be referred to as a cycle. A pattern obtained by changing the display color of the decoration image 300 according to the color to be displayed in the display pattern and the time interval at which the color is changed corresponds to a second pattern image in which the color changes in a second cycle.

For example, when the display pattern is a pattern that causes the decoration image 300 to blink, the display pattern includes information indicating whether the entire decoration image 300 is caused to blink or a portion of the decoration image 300 is caused to blink, and information on a time interval at which the decoration image 300 is caused to blink. When a portion of the decoration image 300 is caused to blink, the display pattern includes information indicating a blinking part and information indicating a blinking order.

A pattern obtained by causing the decoration image 300 to blink according to information indicating whether the entire decoration image 300 in the display pattern is caused to blink or a portion of the decoration image 300 is caused to blink and information indicating the time interval at which the decoration image 300 is caused to blink corresponds to a first pattern image in which the decoration image 300 blinks in a first cycle. A pattern obtained by changing a blinking part of the decoration image 300 according to information indicating a part in which a portion of the decoration image 300 in the display pattern is caused to blink and information indicating a blinking order corresponds to a third pattern in which the lighting part is changed in a third cycle.

When the controller 170 detects the first scene by analyzing a captured image or analyzing audio data, the controller 170 refers to the registration table 187 and acquires the decoration image 300 associated with the detected first scene and information on the display pattern of the decoration image 300. When the controller 170 detects the second scene different from the first scene by analyzing a captured image or analyzing audio data, the controller 170 refers to the registration table 187 and acquires the decoration image 300 associated with the detected second scene and information on the display pattern of the decoration image 300. The controller 170 outputs, to the image processor 150, the acquired decoration image 300 and information on the display pattern.

When the decoration image 300 and the information on the display pattern are input, the image processor 150 performs an image process on the decoration image 300 so that the decoration image 300 matches the display pattern indicated by the information on the display pattern. The image processor 150 generates the composite image 400 by combining the content image 200 with the processed decoration image 300, and outputs, to the image projection unit 160, image information on the generated composite image 400.

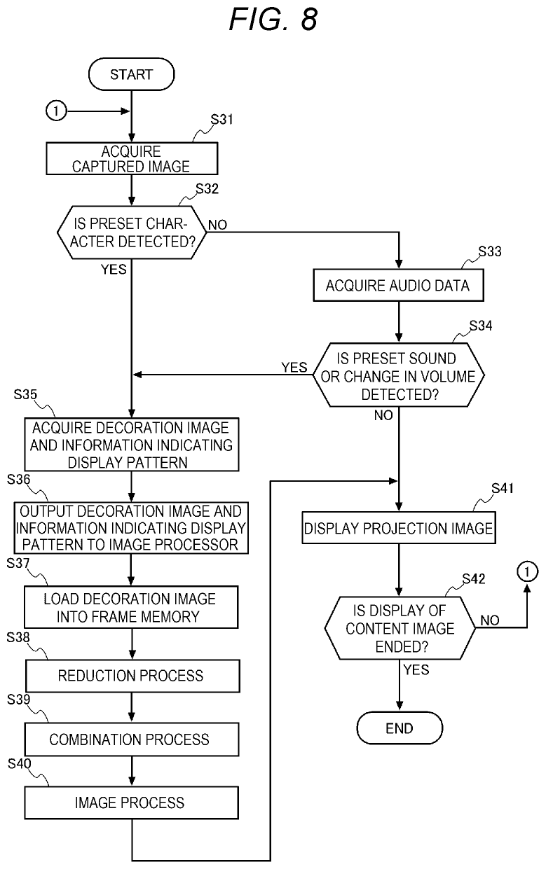

FIG. 8 is a flowchart showing an operation of the projector 100 according to the second embodiment.

The operation of the projector 100 will be described with reference to the flowchart shown in FIG. 8.

First, the controller 170 acquires a captured image captured by the camera 121 from the storage 180 (step S31). Next, the controller 170 analyzes the acquired captured image, and detects preset characters from a range of the captured image in which the screen 50 for the captured image is captured. The controller 170 detects preset characters such as “WIN”, “VICTORY”, “LOSE”, “GAME OVER”, and “LOSS”. Then, the controller 170 determines whether a preset character is detected (step S32).

When a preset character is detected (step S32: YES), the controller 170 acquires, from the registration table 187, the decoration image 300 associated with the detected character and information indicating a display pattern (step S35). The controller 170 outputs, to the image processor 150, the acquired decoration image 300 and the information indicating the display pattern (step S36).

When a preset character is not detected from the captured image (step S32: NO), the controller 170 acquires audio data from the storage 180 (step S33). The controller 170 analyzes the acquired audio data and determines whether a preset sound such as cheer or clapping is detected. The controller 170 determines whether a volume of a song played as BGM or the like changes to a value equal to or more than a preset threshold value.

When the controller 170 does not detect a preset sound or does not detect a change in the volume equal to or more than the preset threshold value (step S34: NO), the controller 170 displays the projection image on the screen 50 (step S41). This projection image is the content image 200 without the decoration image 300. When the decoration image 300 to be displayed is set for each genre, the controller 170 may display, as the projection image, the composite image 400 that is a composite of the content image 200 with the decoration image 300 corresponding to the genre.

Next, the controller 170 determines whether the display of the content image 200 is ended (step S42). For example, the controller 170 determines that the display of the content image 200 is ended when distribution of the packet data from the server device 10 is ended or when the remote control 105 receives an operation of ending the display of the content image 200. When the controller 170 determines that the display of the content image 200 is ended (step S42: YES), the controller 170 ends a processing flow. When the controller 170 determines that the display of the content image 200 is not ended (step S42: NO), the process returns to step S31.

When the controller 170 detects a preset sound or detects a change in the volume equal to or more than the preset threshold value (step S34: YES), the controller 170 acquires, from the registration table 187, the preset associated decoration image 300 and information indicating a display pattern (step S35). The controller 170 outputs, to the image processor 150, the acquired decoration image 300 and the information indicating the display pattern (step S36).

When the decoration image 300 and the information indicating the display pattern are input from the controller 170, the image processor 150 loads the input decoration image 300 into the frame memory 140 (step S37).

Next, the image processor 150 executes a reduction process of reducing the content image 200 input from the controller 170 (step S38). The image processor 150 compares resolution of the content image 200 with width and height information indicated by the disposition information 183 in the decoration image 300, calculates a reduction ratio at which the content image 200 is reduced, and performs a reduction process of reducing the content image 200 at the calculated reduction ratio.

Next, the image processor 150 executes combination process of combining the reduced content image 200 and the decoration image 300 (step S39). The image processor 150 superimposes the content image 200 reduced by the reduction process on the disposition portion 310 of the decoration image 300 loaded into the frame memory 140, and executes a combination process. Accordingly, the composite image 400 is generated in the frame memory 140.

Next, the image processor 150 performs an image process on the decoration image 300 according to the information indicating the display pattern input from the controller 170 (step S40). For example, the image processor 150 executes, according to the information indicating the display pattern, an image process of changing luminance of the decoration image 300 or changing the display color of the decoration image 300.

Next, the projection image is displayed on the screen 50 by the image projection unit 160 (step S41). The image processor 150 outputs, to the image projection unit 160, image information on the composite image 400 generated in the frame memory 140. The image projection unit 160 generates an image light based on the input image information, projects the generated image light, and displays a projection image on the screen 50 (step S41).

Next, the controller 170 determines whether the display of the content image 200 is ended (step S42). For example, the controller 170 determines that the display of the content image 200 is ended when distribution of the packet data from the server device 10 is ended or when the remote control 105 receives an operation of ending the display of the content image 200. When the controller 170 determines that the display of the content image 200 is ended (step S42: YES), the controller 170 ends a processing flow. When the controller 170 determines that the display of the content image 200 is not ended (step S42: NO), the process returns to step S31.

### 4. Operation of Projector in Third Embodiment

Next, a third embodiment to which the present disclosure is applied will be described. Since a configuration of the projector 100 according to the third embodiment is the same as the configuration of the projector 100 according to the first embodiment, the same reference signs are used, and a detailed description of the configuration of the projector 100 will be omitted.

In the third embodiment, in addition to the decoration image 300, an appearance of the OSD image indicating menu information superimposed on the composite image 400 is changed according to a genre of the content image 200. For example, a display mode of the OSD image is changed by changing a shape, a color, a movement, a blinking interval, and the like of the OSD image according to the genre of the content image 200.

For example, the OSD image includes objects indicating operators such as transition to a home screen, source switching, and a setting. The shape and color of these objects are changed according to the genre of the content image 200.

When a movement is set to an object indicating an operator such as transition to a home screen, source switching, and a setting, the movement of the object may be changed according to the genre of the content image 200.

Further, an appearance of a notification image for notifying an operation or state of the projector 100 may also be changed according to the genre of the content image 200.

A font of characters such as “home”, “source switching”, and “setting” displayed in the OSD image may be changed according to the genre of the content image 200. Further, a manner of displaying the OSD image when the OSD image is displayed on the screen 50 may be changed according to the genre of the content image 200. For example, when the genre of the content image 200 is a movie, the OSD image may be slid into the screen 50 from the upper-lower direction of the screen 50. When the genre of the content image 200 is a game, the OSD image may be slid into the screen 50 from a left-right direction of the screen 50.

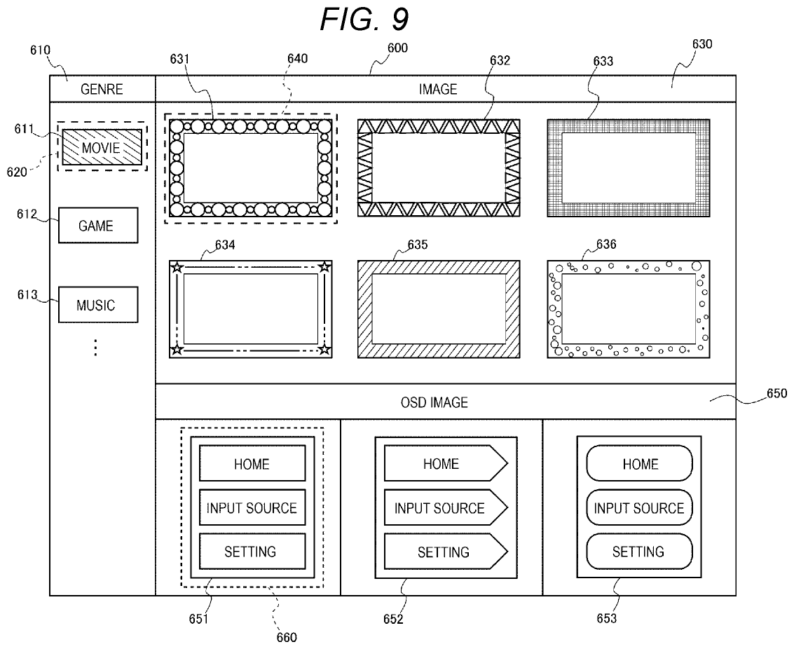

FIG. 9 is a diagram showing a second UI image 600 displayed on the screen 50. FIG. 9 shows the second UI image 600 when the shape of the OSD image is changed. The second UI image 600 shown in FIG. 9 includes an OSD image selection field 650 in addition to a genre selection field 610 and an image selection field 630.

In the OSD image selection field 650, a reduced image obtained by reducing the OSD image displayed as a menu image is displayed. FIG. 9 shows an example in which three reduced images, a first reduced image 651, a second reduced image 652, and a third reduced image 653, are displayed, but the number of reduced images displayed in the OSD image selection field 650 is not limited to three. For example, two reduced images or four or more reduced images may be displayed in the OSD image selection field 650. Any two of the first reduced image 651, the second reduced image 652, and the third reduced image 653 correspond to a first display object or a second display object.

A selection frame 660 is displayed in the OSD image selection field 650.

The user operates left and right keys provided on the remote control 105 to move a display position of the selection frame 660 in the OSD image selection field 650. For example, when the right key of the remote control 105 is pressed once in a display state of the OSD image selection field 650 shown in FIG. 9, the display position of the selection frame 660 is changed from the first reduced image 651 to a display position of the second reduced image 652.

When one of the object selected in the genre selection field 610, a thumbnail image selected in the image selection field 630, and a reduced image selected in the OSD image selection field 650 is selected, the controller 170 generates combination information. The combination information is information that associates information indicating the genre corresponding to an icon image, identification information on the decoration image 300 corresponding to the selected thumbnail image, and identification information on the selected reduced image.

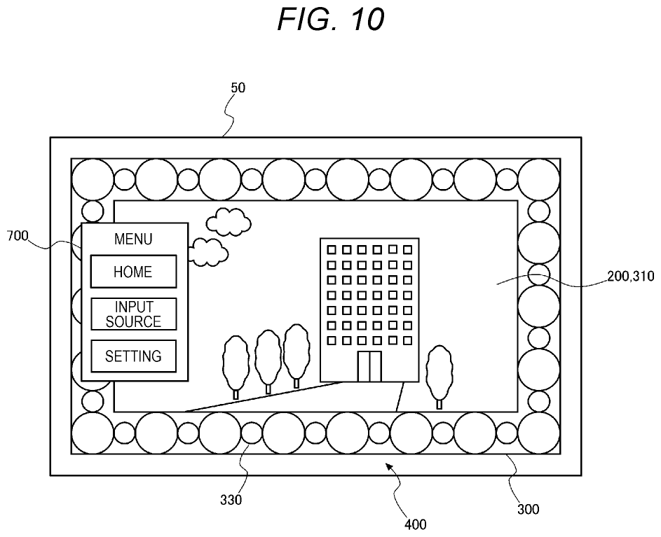

FIG. 10 is a diagram showing an example of the OSD image superimposed on the composite image 400.

FIG. 10 shows a projection image in which an OSD image 700 corresponding to the first reduced image 651 selected in the second UI image 600 shown in FIG. 9 is displayed.

When a button provided on the remote control 105 is operated and a display of a menu image is requested, the controller 170 refers to the combination information and acquires identification information on a reduced image associated with the genre of the content image 200. For example, when a movie is selected as the genre of the content image 200, the controller 170 refers to the combination information, and acquires the identification information on the reduced image of the OSD image associated with the movie. When the game is selected as the genre of the content image 200, the controller 170 refers to the combination information, and acquires the identification information on the reduced image of the OSD image associated with the game and having an appearance different from that of the reduced image of the OSD image associated with the genre as the movie. The controller 170 outputs, to the image processor 150, information on the OSD image 700 corresponding to the acquired identification information on the reduced image and coordinate information for disposing the OSD image 700.

The image processor 150 causes the OSD processor 155 to acquire OSD image information representing graphics, fonts, and the like from the OSD memory, based on information on the OSD image 700 input from the controller 170. The OSD processor 155 generates the OSD image 700 based on the acquired OSD image information, and superimposes the OSD image 700 on coordinates of the frame memory 140 indicated by the coordinate information input from the controller 170. The image processor 150 reads image information on an image in which the OSD image 700 is superimposed on the composite image 400, and outputs the read image information to the image projection unit 160.

### 5. Other Embodiments

The above-described embodiments are preferred embodiments. The present disclosure is not limited to the above-described embodiments, and various modifications can be made within the scope not departing from the gist.

For example, in the first embodiment described above, the controller 170 of the projector 100 determines a genre of the content image 200 and displays the decoration image 300 associated with the determined genre. In the second embodiment, the controller 170 of the projector 100 determines the situation and the scene displayed in the content image 200, and displays the decoration image 300 associated with the determined situation and scene.

As another example, an information processing device may be coupled to the projector 100, and the genre of the content image 200 and a situation or scene displayed in the content image 200 may be determined by an application program installed in the information processing device. The application program transmits, to the projector 100, the determined genre of the content image 200 and identification information for identifying the decoration image 300 associated with the situation or scene displayed in the content image 200. The application program may transmit the decoration image 300 itself to the projector 100. As the information processing device, for example, a notebook PC, a desktop PC, a tablet PC, and a smartphone are used.

The smart TVAPP 181 installed in the projector 100 may be installed in the information processing device. A smart TV device having the same function as when the processor 190 executes the smart TVAPP 181 may be coupled to the projector 100.

A trained model may be stored in the storage 180 of the projector 100.

The trained model is a model in which the genre of the content image 200 and a state or scene of the content image 200 are input as input information, and the decoration image 300 selected by the user or the display pattern of the decoration image 300 is trained as output information. The trained model is a model trained by machine learning such as deep learning. The trained model is implemented with a so-called neural network.

The controller 170 inputs, to the trained model, a genre of the content image 200 determined based on tag information. The controller 170 inputs, to the trained model, a state or scene of the content image 200 detected from a captured image captured by the camera 121 or audio data of the microphone 127. The trained model outputs identification information on the decoration image 300 and information indicating a display pattern of the decoration image 300.

The controller 170 outputs, to the image processor 150, the decoration image 300 corresponding to the identification information output from the trained model, and causes the decoration image 300 to be combined with the content image 200. The controller 170 causes the image processor 150 to execute an image process of the decoration image 300 according to the information indicating the display pattern output from the trained model.

The first condition and the second condition described in the above embodiment may be exclusive conditions, or may be conditions that are simultaneously satisfied. That is, one content image 200 may correspond to the first condition and the second condition. For example, it is assumed that the first condition indicates that the genre of the content image 200 is a movie, and the second condition indicates that the genre of the content image 200 is an animation. In this case, the content image 200 which is an animated movie corresponds to both the first condition and the second condition. Thus, when the first condition and the second condition are simultaneously satisfied, priority may be set in advance for the first condition and the second condition. When one content image 200 corresponds to both the first condition and the second condition, the controller 170 combines the decoration image 300 associated with the first condition or the decoration image 300 associated with the second condition with the content image 200 according to the priority.

In the embodiment, a case where the content image 200 is a moving image is described, but the content image 200 may also be a still image.

In the embodiment, a case where three transmissive liquid crystal panels 163 are provided as the light modulation device is described, but an embodiment to which the present disclosure is applied is not limited thereto. A light modulation element may be a reflective liquid crystal panel or a digital micromirror device.

Each functional unit shown in FIG. 1 shows a functional configuration, and a specific implementation form is not particularly limited. That is, it is needless to say that hardware corresponding to each functional unit is not necessarily implemented, and functions of a plurality of functional units may be implemented with one processor executing a program. In the above-described embodiments, a part of functions implemented with software may be implemented with hardware, or a part of functions implemented with hardware may be implemented with software.

When a display method and a program are implemented by using a computer in the projector 100, the program to be executed by the computer may be implemented in the form of a recording medium or a transmission medium for transmitting the program. A magnetic or optical recording medium, or a semiconductor memory device may be used as the recording medium. Specific examples include a portable or fixed recording medium such as a flexible disk, a hard disk drive (HDD), a CD-ROM, a DVD, a Blu-ray Disc, a magneto-optical disk, a flash memory, and a card type recording medium. The recording medium may be a nonvolatile storage device such as a RAM, a ROM, or an HDD, which is an internal storage device in the server device 10. Blu-ray is a registered trademark.

### 6. Summary of Present Disclosure

Hereinafter, a summary of the present disclosure is appended below.

### Appendix 1

A display method including: acquiring content information indicating a content of a first image; displaying a second image disposed along an outline of the first image outside the first image when the content information meets a first condition; and displaying a third image disposed along the outline of the first image outside the first image and having a color or a pattern different from the second image, when the content information meets a second condition, which is different from the first condition.

Accordingly, when the content information meets the first condition, the second image disposed along the outline of the first image outside the first image is displayed. When the content information meets the second condition, the third image disposed along the outline of the first image outside the first image is displayed. Therefore, it is possible to increase a degree of freedom of the displayed image and improve convenience for the user.

### Appendix 2

The display method according to Appendix 1, in which the content information indicates a genre of the first image, the first condition is that the genre of the first image is a first genre, and the second condition is that the genre of the first image is a second genre, which is different from the first genre.

Accordingly, when the content information meets the first genre, the second image disposed along the outline of the first image outside the first image is displayed. When the content information meets the second genre, the third image disposed along the outline of the first image outside the first image is displayed. Therefore, it is possible to change the image disposed along the outline of the first image outside the first image in accordance with the genre of the first image.

### Appendix 3

The display method according to Appendix 1 or 2, in which the first image is a part of a video that changes with time, the content information indicates a scene of the first image in the video, the first condition is that the scene of the first image is a first scene, and the second condition is that the scene of the first image is a second scene, which is different from the first scene.

Accordingly, when the scene indicated by the content information is the first scene, the second image disposed along the outline of the first image outside the first image is displayed. When the scene indicated by the content information is the second scene, the third image disposed along the outline of the first image outside the first image is displayed. Therefore, it is possible to change the image disposed along the outline of the first image outside the first image in accordance with the scene of the first image.

### Appendix 4

The display method according to any one of Appendixes 1 to 3, further including: receiving an input designating a combination of one candidate condition among a plurality of candidate conditions that are candidates for the first condition and one candidate image among a plurality of candidate images that are candidates for the second image; and receiving an input designating a combination of another candidate condition among the plurality of candidate conditions that are candidates for the second condition and another candidate image among the plurality of candidate images that are candidates for the third image, in which displaying the second image includes displaying the one candidate image as the second image when the content information meets the one candidate condition, and displaying the third image includes displaying the other candidate image as the third image when the content information meets the other candidate condition.

Accordingly, by designating a combination of the candidate condition and one candidate image, when the first image corresponds to the designated candidate condition, the designated candidate image is displayed as the second image. By designating the combination of the other candidate condition and the other candidate image, when the first image corresponds to the designated another candidate condition, the designated candidate image is displayed as the third image. Therefore, it is possible to increase a degree of freedom of the displayed image and improve convenience for the user.

### Appendix 5

The display method according to Appendix 4, in which the plurality of candidate images include at least two of a first pattern image that blinks in a first cycle, a second pattern image whose color changes in a second cycle, and a third pattern image whose lighting part changes in a third cycle.

Accordingly, at least one of the first pattern image, the second pattern image, and the third pattern image can be selected as the second image. Therefore, at least one of the first pattern image, the second pattern image, and the third pattern image can be selected and displayed as the second image.

### Appendix 6

The display method according to any one of Appendixes 1 to 5, in which when the content information meets the first condition, a first display object having a first appearance associated with the first condition and indicating menu information is displayed, and when the content information meets the second condition, a second display object having a second appearance associated with the second condition and different from the first appearance and indicating the menu information is displayed.

Accordingly, when the content information meets the first condition, the first display object having at least one of a color, a shape, and a blinking pattern associated with the first condition is displayed. When the content information meets the second condition, the second display object having at least one of a color, a shape, and a blinking pattern associated with the second condition is displayed. Therefore, it is possible to increase a degree of freedom of the displayed image and improve convenience for the user.

### Appendix 7

A display device including: an optical device; and at least one processor, in which the at least one processor executes operations of acquiring content displaying a second image disposed along an outline of the first image outside the first image by controlling the optical device when the content information meets a first condition, and displaying a third image disposed along the outline of the first image outside the first image and having a color or a pattern different from the second image by controlling the optical device, when the content information meets a second condition, which is different from the first condition.

Accordingly, when the content information meets the first condition, the second image disposed along the outline of the first image outside the first image is displayed. When the content information meets the second condition, the third image disposed along the outline of the first image outside the first image is displayed. Therefore, it is possible to increase a degree of freedom of the displayed image and improve convenience for the user.

### Appendix 8

A non-transitory computer-readable storage medium storing a program, the program causing a computer to execute operations including: acquiring content information indicating a content of a first image; displaying a second image disposed along an outline of the first image outside the first image when the content information meets a first condition; and displaying a third image disposed along the outline of the first image outside the first image and having a color or a pattern different from the second image, when the content information meets a second condition, which is different from the first condition.

Accordingly, when the content information meets the first condition, the second image disposed along the outline of the first image outside the first image is displayed. When the content information meets the second condition, the third image disposed along the outline of the first image outside the first image is displayed. Therefore, it is possible to increase a degree of freedom of the displayed image and improve convenience for the user.

What is claimed is:

1. A display method comprising:
acquiring content information indicating a content of a first image;
displaying a second image disposed along an outline of the first image outside the first image when the content information meets a first condition; and
displaying a third image disposed along the outline of the first image outside the first image and having a color or a pattern different from the second image, when the content information meets a second condition, which is different from the first condition.

2. The display method according to claim 1, wherein
the content information indicates a genre of the first image,
the first condition is that the genre of the first image is a first genre, and
the second condition is that the genre of the first image is a second genre which is different from the first genre.

3. The display method according to claim 1, wherein
the first image is a part of a video that changes with time,
the content information indicates a scene of the first image in the video,
the first condition is that the scene of the first image is a first scene, and
the second condition is that the scene of the first image is a second scene which is different from the first scene.

4. The display method according to claim 1, further comprising:
receiving an input designating a combination of one candidate condition among a plurality of candidate conditions that are candidates for the first condition and one candidate image among a plurality of candidate images that are candidates for the second image; and
receiving an input designating a combination of another candidate condition among the plurality of candidate conditions that are candidates for the second condition and another candidate image among the plurality of candidate images that are candidates for the third image, wherein
displaying the second image includes displaying the one candidate image as the second image when the content information meets the one candidate condition, and
displaying the third image includes displaying the other candidate image as the third image when the content information meets the other candidate condition.

5. The display method according to claim 4, wherein
the plurality of candidate images include at least two of a first pattern image that blinks in a first cycle, a second pattern image whose color changes in a second cycle, and a third pattern image whose lighting part changes in a third cycle.

6. The display method according to claim 1, wherein
when the content information meets the first condition, displaying a first display object having a first appearance associated with the first condition and indicating menu information, and
when the content information meets the second condition, displaying a second display object having a second appearance associated with the second condition and different from the first appearance and indicating the menu information.

7. A display device comprising:
an optical device; and
at least one processor programmed to execute operations of
acquiring content information indicating a content of a first image,
displaying a second image disposed along an outline of the first image outside the first image by controlling the optical device when the content information meets a first condition, and
displaying a third image disposed along the outline of the first image outside the first image and having a color or a pattern different from the second image by controlling the optical device, when the content information meets a second condition, which is different from the first condition.

8. A non-transitory computer-readable storage medium storing a program, the program causing a computer to execute operations comprising:
acquiring content information indicating a content of a first image;
displaying a second image disposed along an outline of the first image outside the first image when the content information meets a first condition; and
displaying a third image disposed along the outline of the first image outside the first image and having a color or a pattern different from the second image, when the content information meets a second condition, which is different from the first condition.
